(19) United States
(12) Patent Application Publication
(10) Pub. No.: US 2025/0299678 A1
(43) Pub. Date: Sep. 25, 2025

(54) METHODS, DEVICES, AND SYSTEMS FOR DIRECTIONAL SPEECH RECOGNITION WITH ACOUSTIC ECHO CANCELLATION

(71) Applicant: Meta Platforms Technologies, LLC, Menlo Park, CA (US)

(72) Inventors: Ju Lin, Seattle, WA (US); Yiteng Huang, Basking Ridge, NJ (US); Xin Lei, Bellevue, WA (US); Ming Sun, Seattle, WA (US); Frank Torsten Bernd Seide, Yarrow Point, WA (US); Vahid Khanagha, Rockville, MD (US); Kaustubh Kalgaonkar, Bellevue, WA (US); Yang Liu, Port Jefferson Station, NY (US); Hoang Huy Do, Jersey City, NJ (US); Michael Lewis Seltzer, Seattle, WA (US)

(21) Appl. No.: 19/074,302

(22) Filed: Mar. 7, 2025

Related U.S. Application Data
(60) Provisional application No. 63/568,384, filed on Mar. 21, 2024.

(51) Int. Cl. G10L 15/26; G10L 21/0208; G10L 21/0216; G10L 21/0232

(52) U.S. Cl. CPC G10L 15/26; G10L 21/0232; G10L 2021/02082; G10L 2021/02166

(57) ABSTRACT

An example method of providing speech-to-text transcription includes receiving, at an electronic device, multiple channels of audio data from a plurality of microphones, where the multiple channels of audio data comprise speech from a user of the electronic device and speech from one or more other persons. The method also includes generating refined audio data by applying a multi-path acoustic echo cancellation (AEC) technique to the multiple channels of audio data. The method further includes generating directional audio data by applying beamforming to the refined audio data. The method also includes identifying, by inputting the directional audio data to an automatic speech recognizer (ASR), the speech from the user of the electronic device and the speech from the one or more other persons, and generating a textual transcription for the conversation.

### PRIORITY AND RELATED APPLICATIONS

This application claims priority to U.S. Provisional Patent App. No. 63/568,384, filed Mar. 21, 2024, which is hereby incorporated by reference in its entirety.

### TECHNICAL FIELD

This relates generally to systems and methods of directional speech recognition, including but not limited to techniques for processing directional speech using acoustic echo cancellation training.

### BACKGROUND

Electronic devices, such as wearable devices (e.g., smart glasses), are commonly equipped with microphones to receive audio and speakers to output audio and computational capabilities sufficient for Automatic Speech Recognition (ASR). However, when receiving audio from multiple sources, it is challenging to distinguish between the sources. Distinguishing between different audio sources is particularly important when transcribing the audio, providing live captioning, and providing speech-to-text and text-to-speech features. These capabilities may be particularly important for hearing-impaired users and users experiencing language barriers. Additionally, echoes can distort the audio and eliminating echoes from the received audio is challenging. As such, there is a need to address one or more of the above-identified challenges. A brief summary of solutions to the issues noted above are described below.

### SUMMARY

The systems and methods disclosed herein leverage multiple microphones (e.g., a multi-microphone array embedded in a head-wearable device or other type of device) to discern speakers, reduce echoes, and differentiate between audio from the wearer, the conversation partner, unrelated bystanders, and/or other audio sources (e.g., environmental noise). Some of the disclosed systems utilize a multi-path acoustic echo cancellation (AEC) technique to remove echoes from multi-channel audio. The multi-path AEC techniques described herein improve the audio quality by removing noise related to audio echo, which is particularly important for systems with speakers that play back audio collected by the microphones. Some of the disclosed systems utilize beam forming (e.g., segmenting the input audio to a plurality of segments corresponding to different sectors of the environment). The disclosed beam-forming techniques allow the system to distinguish between audio sources in the environment, which is particularly important for source attribution and audio spatialization. Some of the disclosed systems utilize an ASR component configured (e.g., trained) to recognize and attribute speech in multi-path AEC audio. Such an ASR component can provide improved audio quality and more accurately perform speech recognition and attribution, thereby providing more accurate transcription (e.g., with a word-error rate (WER) reduced by over 70% as compared to systems without AEC).

As an illustrative example, suppose a person, Riley, wants to have a conversation with another person who doesn't speak the same language as Riley. Conventionally, Riley may need to rely on a translator or translation dictionary to overcome the language barrier. If Riley is wearing a head-wearable device (or using another type of electronic device) with the systems disclosed herein, while the other person is talking, the head-wearable device can differentiate the other person's voice from Riley's voice and other background noise. Once the other person's voice is distinguished, the head-wearable device can recognize the other person's speech, translate the speech to a language that Riley understands, and provide the translation to Riley. For example, the head-wearable device may display close captions (speech-to-text) that Riley can read while the other person is talking. As another example, the head-wearable device may provide translated audio (e.g., text-to-speech) corresponding to the other person's speech. Using the AEC, beamforming, and ASR components and techniques described herein, the output from the head-wearable device may be more accurate than conventional systems that fail to distinguish between different audio sources.

In another illustrative example, supposed Riley is hard of hearing (is experiencing hearing loss) and is trying to have a conversation with several persons while in a noisy environment. Although they are speaking the same language, Riley may not be able to hear or understand what the other people are saying (e.g., due to distance, relative volume, and/or background noise). Conventionally, Riley may need to maintain a very close distance with each person, focus on reading each person's lips, and/or asking each person to speak very loudly. If Riley is wearing a pair of smart glasses (or using another type of electronic device) with the systems disclosed herein, the smart glasses can differentiate each person's voice (e.g., from Riley's voice and other background noise) and then provide speech-to-text output (e.g., captions) for Riley to read and/or amplified audio for each person's speech. The speech-to-text and/or amplified audio may be provided with attribution to the person speaking so that Riley knows who said what. Using the AEC, beamforming, and ASR components and techniques described herein, the output from the head-wearable device may be more accurate than conventional systems that fail to distinguish between and separate different audio sources.

An example extended-reality (XR) headset may include one or more cameras, one or more displays (e.g., placed behind one or more lenses), and one or more programs, where the one or more programs are stored in memory and configured to be executed by one or more processors. The one or more programs including instructions for performing operations. The operations may include receiving multiple channels of audio data from a plurality of microphones. In this example, the multiple channels of audio data include speech from a user of the headset and speech from one or more other persons. The operations further include receiving output audio data from one or more speakers, generating refined audio data by applying a multi-path AEC technique to the multiple channels of audio data using the output audio data from the one or more speakers as reference data, and generating directional audio data by applying beamforming to the refined audio data. In this example, the directional audio data has more channels than the multiple channels of audio data. The operations further include identifying, by inputting the directional audio data to an ASR, the speech from the user of the electronic device and the speech from the one or more other persons, and generating a textual transcription for the conversation, where the textual transcription does not include the speech from the user of the electronic device.

Instructions that cause performance of the methods and operations described herein can be stored on a non-transitory computer-readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an XR headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an XR headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a MR headset or a pair of AR glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes. Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1B illustrate an example user scenario involving displaying words spoken by another person, in accordance with some embodiments.

FIG. 2 illustrates example audio data processing, in accordance with some embodiments.

FIG. 3 shows an example method flow chart for determining directional speech, in accordance with some embodiments.

FIGS. 4A, 4B, 4C-1, and 4C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

As described previously, the embodiments disclosed herein include systems and methods of providing speaker-specific outputs for captured speech. An example method includes receiving multiple channels of audio data (e.g., from a set of microphones on one or more devices), refining the audio data by applying multi-path AEC, generating directional audio data by applying beamforming to the refined audio data, identifying, from the directional audio data, speech and the corresponding speaker, and generating a transcription of the speech with attribution to the corresponding speaker. In some embodiments, the transcription does not include speech from the user (e.g., the user's own speech is recognized, attributed, and withheld from the transcription). The methods described herein can improve speech recognition accuracy (e.g., reducing the corresponding WER) as compared to conventional methods of speech recognition.

Embodiments of this disclosure can include or be implemented in conjunction with various types of XRs, such as MR and AR systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO2) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Directional Speech Recognition

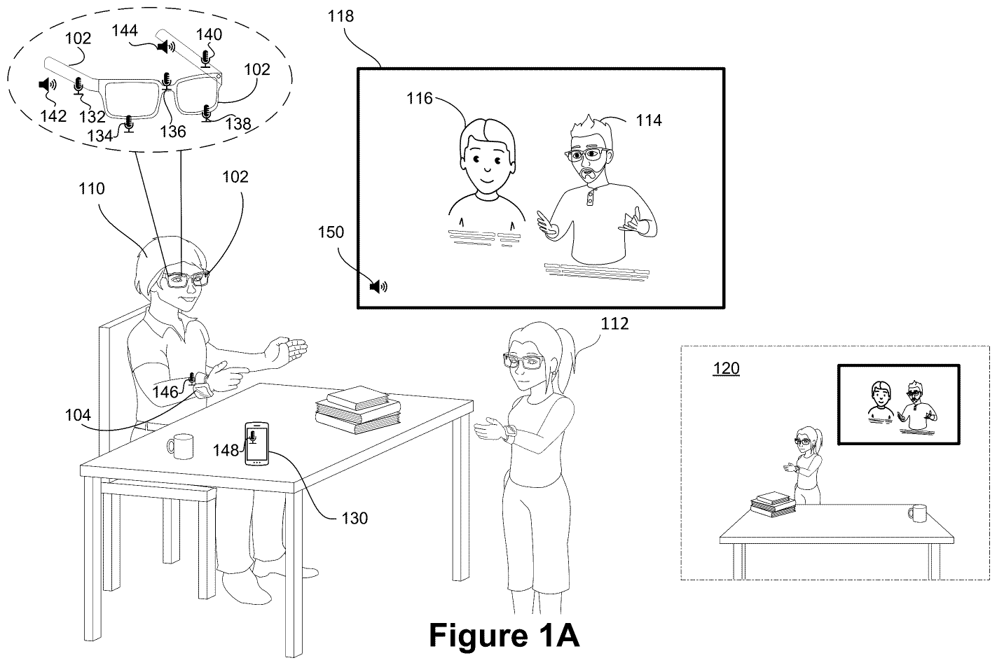

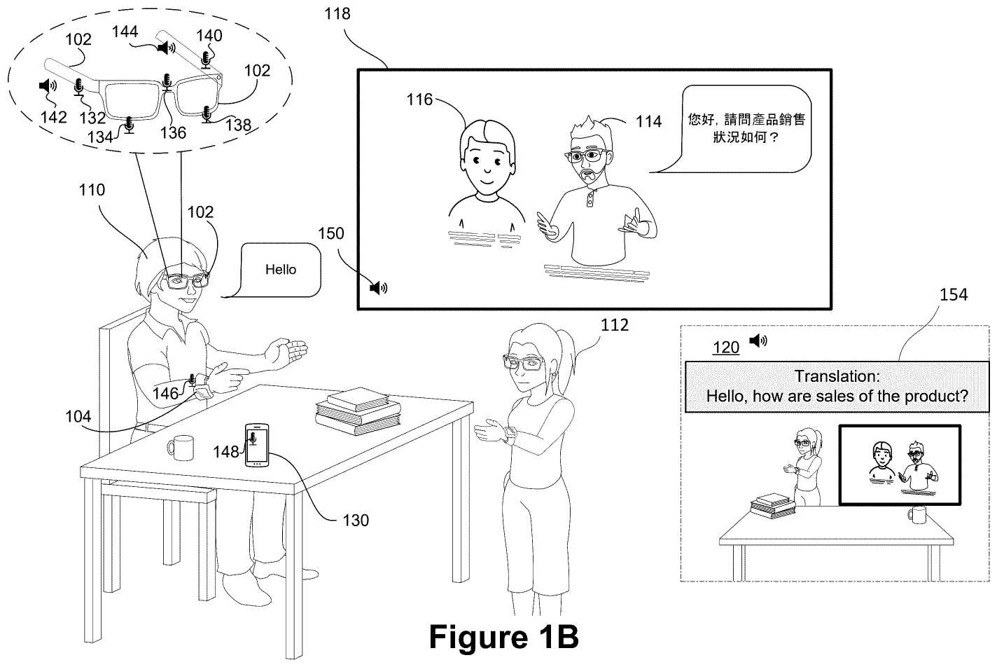

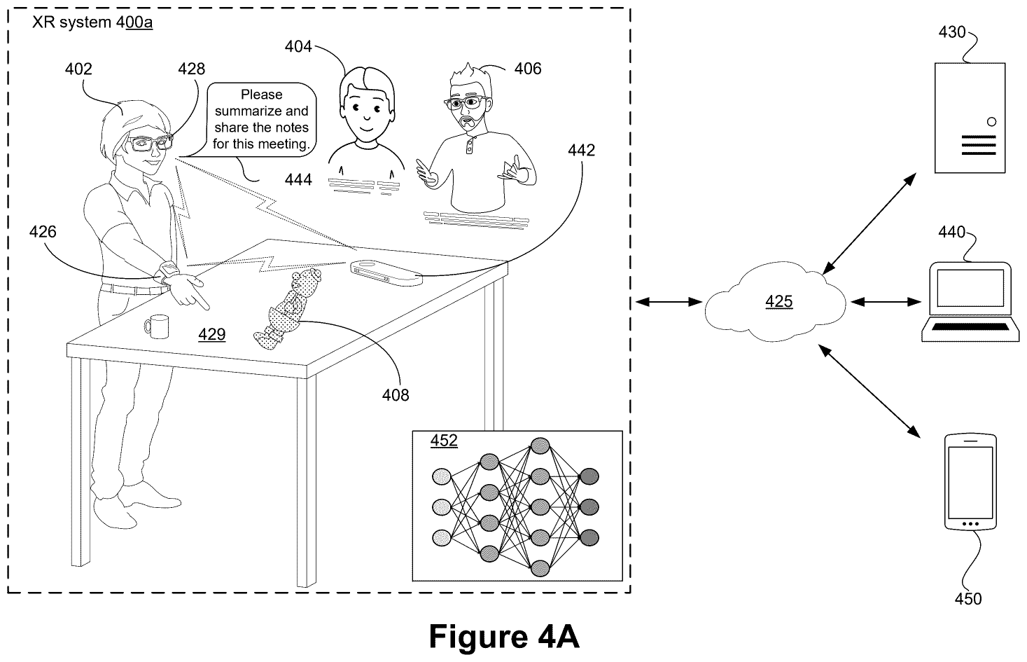

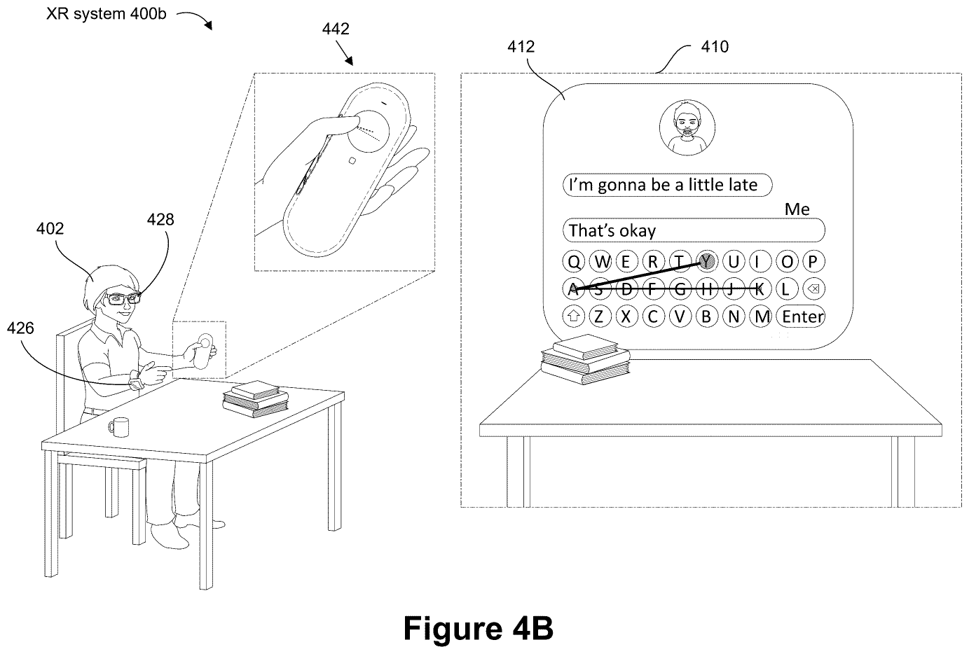

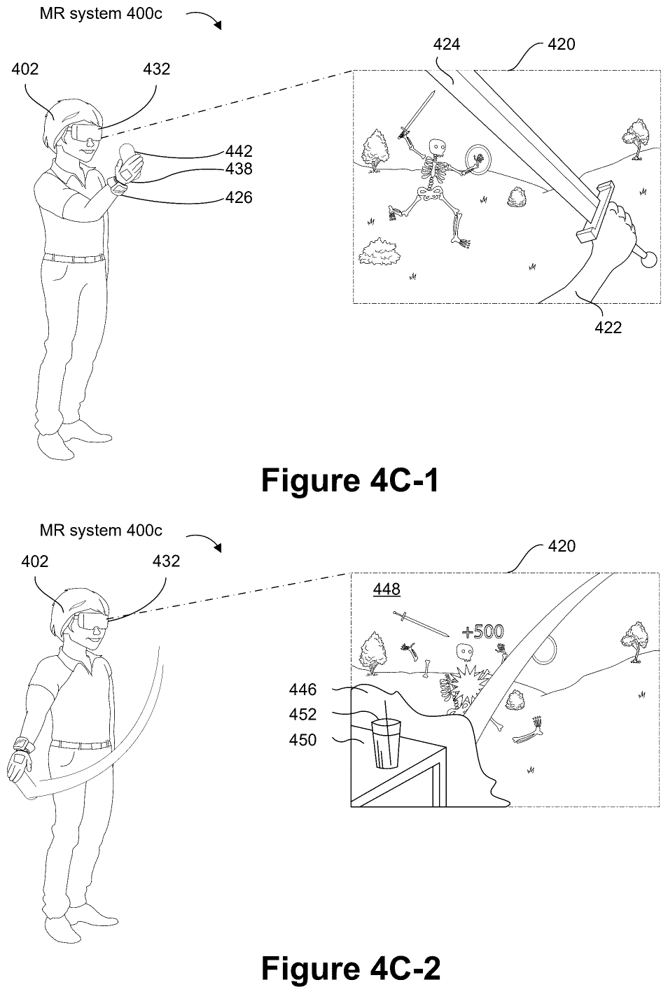

FIGS. 1A-1B illustrate an example user scenario involving displaying words spoken by another person, in accordance with some embodiments. The user 110 in FIG. 1A is wearing a head-wearable device 102 (e.g., an extended-reality headset) and a wrist-wearable device 104. In some embodiments, the head-wearable device 102 is an instance of 428 in FIG. 4A and the wrist-wearable device 104 is an instance of 428 in FIG. 1A. The user 110 in FIG. 1A is in a meeting with one or more other people (e.g., person 112, person 114, and person 116). The person 112 is in the meeting room in-person with the user 110 whereas the persons 114 and 116 are in the meeting virtually and displayed on a screen 118 (e.g., a television or monitor). The user 110 is viewing a scene 120 that includes the other people in the meeting. In some embodiments, the scene 120 is displayed on at least one lens of the head-wearable device 102.

The head-wearable device 102 includes a plurality of microphones (e.g. a microphone 132, a microphone 134, a microphone 136, a microphone 138, and a microphone 140) and at least one speaker (e.g., speaker 142 and speaker 144) as components of the head-wearable device 102. In some embodiments, one or more of the microphones are separate from, and communicatively coupled to, the head-wearable device 102. In some embodiments, one or more microphones are communicatively coupled to the head-wearable device 102, including a wrist-wearable device microphone 146 and a smartphone microphone 148, and are configured to receive audio data and transmit the audio data to the head-wearable device 102.

In some embodiments, one or more of the speakers are separate from, and communicatively coupled to, the head-wearable device 102. In accordance with some embodiments, the plurality of microphones are configured to receive audio data including audio from the user 110 (e.g., speech) as well as audio from the environs (e.g., from other people, background noise, and/or audio from one or more other devices (e.g., wrist-wearable device 104, smartphone 130, screen 118, etc.)). In some embodiments, the audio data includes audio output from one or more speakers including: the speaker 142, the speaker 144, and the speaker 150. Additionally, in some embodiments, the output audio data includes speech generated using a text-to-speech technique. For example, if the output (e.g., the translation) of the system illustrated in FIG. 1B is provided to the user 110 via speaker 142 and/or speaker 144 of the head-wearable device 102, the audio output will be received by one of the microphones 132-148 at the head-wearable device 102. As described below, the system is configured to cancel out the audio data received from the text-to-speech technique (e.g., audio emanating from the speakers 142 and/or 144 at the head-wearable device 102).

In some embodiments, the head-wearable device 102 includes the audio processing components described herein (e.g., the AEC component, the beamformer component, and the ASR component). In some embodiments, one or more of the audio processing components are components of a separate device (e.g., the wrist-wearable device 104) that is communicatively coupled with the head-wearable device 102. For example, the audio processing may occur, at least in part, at the smartphone 130 and the corresponding output is provided at the head-wearable device 102 (e.g., for display via a screen of the or display of the head-wearable device and/or output via one or more speakers of the head-wearable device).

FIG. 1B shows the person 114 speaking to the user 110 in a language not known to the user 110. FIG. 1B further illustrates the head-wearable device 102 receiving audio from the user 110 saying “hello” and audio output from the speaker 150 by using at least one of the plurality of microphones integrated with or communicatively coupled to the head-wearable device 102 in accordance with some embodiments. For example, the microphone 132, the microphone 134, the microphone 136 may receive audio data that is primarily from the user 110 and the microphone 136, the microphone 138, and the microphone 140 may receive audio output that is primarily from the speaker 150. In some embodiments, the head-wearable device 102 applies a multi-path AEC process to the audio data from the set of microphones to remove echoes (e.g., caused by output from the speakers 142, 144, and/or 150). In some embodiments, the head-wearable device 102 applies a beam-forming process to the audio data from the set of microphones (e.g., after the multi-path AEC process is complete) to generate directional data. For example, the head-wearable device 102 may convert 5 channels of audio data from the 5 microphones into 13 channels of directional data. In some embodiments, the head-wearable device 102 performs an ASR process on the directional data to recognize speech from the audio data and attribute it to the corresponding speaker.

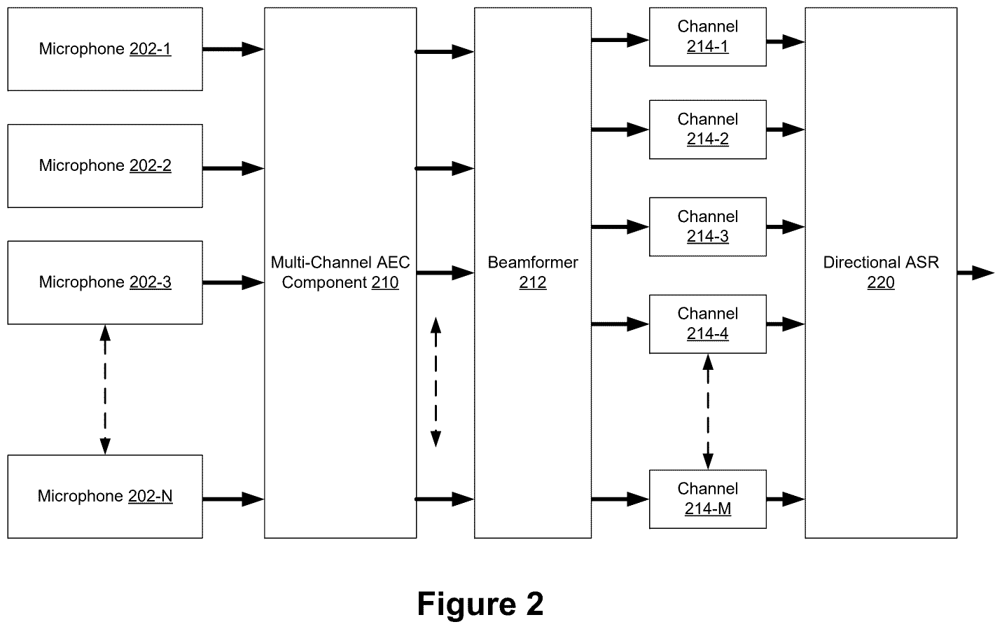

FIG. 1B further illustrates that in response to the person 114 speaking to the user 110, the head-wearable device 102 translates the words from the person 114 and displays the translation to the user 110 via a translation user interface element 154. In some embodiments, the head-wearable device 102 (e.g., the speakers 142 and 144 of the head-wearable device 102) output translated audio to the user 110. In some embodiments, one or more of the processes described above with respect to head-wearable device 102 are performed by a different electronic device and the results are transmitted to the head-wearable device 102. The operations of processing the audio data are described further below in reference to FIG. 2. In some embodiments, during the processing, the head-wearable device 102 filters out speech from the user 110 (e.g., only displays the translation of the speech from the person 114).

FIG. 2 illustrates example audio data processing (e.g., to generate a textual representation of the audio data and/or processed audio data to a user), in accordance with some embodiments. As described in FIGS. 1A and 1B, the head-wearable device 102 can receive audio via one or more microphones including at the plurality of microphones at the head-wearable device 102 (e.g., the microphone 132) and via communicatively-coupled microphones (e.g., the microphone 146 and microphone 148). As also discussed in FIGS. 1A and 1B, the audio can come from multiple sources including another person (e.g., the person 114), a user of the head-wearable device 102, the person 112, and/or the speakers of another device (e.g., the speaker 150).

The components shown in FIG. 2 may be components of a single electronic device (e.g., the head-wearable device 102) or may be components of multiple devices (e.g., the microphones may be at a first device, the AEC processing may be at a second device, and the ASR may be at a third device). FIG. 2 shows a plurality of microphones 202 (e.g., microphones 202-1 through 202-N). In some embodiments, the microphones 202 are components of a same device (e.g., the head-wearable device 102). In some embodiments, a subset of the microphones (e.g., the microphones 202-2 and 202-3 are components of a different device (e.g., the wrist-wearable device 104).

In accordance with some embodiments, the multi-channel AEC component 210 receives N channels of audio data corresponding to the N microphones 202. The multi-channel AEC component 210 is configured to receive multiple channels of audio data and generate a refined version of the received audio data by applying multi-path AEC techniques to the multiple channels of audio data. Additionally, output audio data from one or more speakers (e.g., from the speakers of the head-wearable device 102) may be used as reference data to identity echoing in the audio data. The multi-path AEC techniques may include applying a linear filter to the multiple channels of audio data. For example, a linear filter may be used so as to not compromise the phase information of the audio data such that the directional components of the audio data are not distorted (e.g., are untouched) and can be analyzed during by the beamformer 212. In some embodiments, the linear filter is a single-time varying linear filter configured to prevent distortion of the multiple channels of audio data. In some embodiments, the linear filter includes a frequency-domain normalized least-mean-square algorithm which allows a fast Fourier transform (FFT) to minimize computational cost and remove echoing from the multiple channels of audio data. This approach may utilize a background filter that is adapted as a conventional echo canceller and a foreground canceller to perform actual cancelation. In this way, an acoustic echo that is a result of multiple audio channels receiving audio data is reduced (e.g., removed) from the audio data. In some embodiments, the multi-path AEC techniques include applying a recursive least squares (RLS) algorithm to remove echoing from the multiple channels of audio data. In some embodiments, the RLS algorithm is applied to an output of the FFT (e.g., to further remove echoing from the multiple channels of audio data).

In another example, the linear filter uses a short-time Fourier transform (STFT). In some embodiments, using a K-point STFT analysis including a linear convolution, as shown in Equation 1, is converted into a sum of K cross-band filter convolutions in the STFT domain, which is necessary to cancel the aliasing caused by down sampling in each frequency sub-band. This process produces Equation 2. In some embodiments of Equation 1, t is the discrete time index, * indicates linear convolution, xₚ(t) is the pth reference signal, and s(t) is the mixture of user speech u(t) (e.g., received from the multiple microphones) and background noise v(t).

$$y ( t ) = {\sum }_{p = I}^{P} {h}_{p} * {x}_{p} ( t ) + s ( t ) . \qquad Equation l$$

$$Y ( k , n ) = {\sum }_{p = 1}^{P} {H}_{p} ( k ) {X}_{p} ( k , n ) + S ( k , n ) . \qquad Equation 2$$

In some embodiments, long impulse responses with a shorter analysis window (smaller K) are necessary, and thus the convolutive transfer function (CTF) approximation is more accurate and less restrictive as shown in Equation 3.

$$Y ( k , n ) = {\sum }_{p = 1}^{P} {\sum }_{l = 0}^{L - 1} {H}_{p} ( k , l ) {X}_{p} ( k , n - 1 ) + S ( k , n ) = {h}^{T} ( k ) X ( k , n ) + S ( k , n ) . \qquad Equation 3$$

Where the Equations 4-7 are representative of the variables in Equation 3.

$$h ( k ) {=}^{△} {[ {h}_{1}^{T} ( k ) {h}_{2}^{T} ( k ) … {h}_{P}^{T} ( k ) ]}^{T} . \qquad Equation 4$$

$$x ( k , n ) {=}^{△} {[ {x}_{1}^{T} ( k , n ) {x}_{2}^{T} ( k , n ) … {x}_{P}^{T} ( k , n ) ]}^{T} . \qquad Equation 5$$

$${h}_{p} ( k ) {=}^{△} {[ {H}_{p} ( k , 0 ) {H}_{p} ( k , 1 ) … {H}_{p} ( k , L - 1 ) ]}^{T} . \qquad Equation 6$$

$${x}_{p} ( k , n ) {=}^{△} {[ {X}_{p} ( k , n ) {X}_{p} ( k , n - 1 ) … {X}_{p} ( k , n - L + 1 ) ]}^{T} . \qquad Equation 7$$

To solve for an estimate of h (k) in each frame, the RLS algorithm is utilized as shown in Equation 8.

$$\hat{h} ( k , n ) = {R}_{xx}^{- 1} ( k , n ) {r}_{x y} ( k , n ) . \qquad Equation 8$$

$${R}_{x x} ( k , n ) = λ {R}_{x x} ( k , n - 1 ) + ( 1 - λ ) x ( k , n ) {x}^{H} ( k , n ) . \qquad Equation 9$$

$${r}_{x y} ( k , n ) = λ {r}_{x y} ( k , n - 1 ) + ( 1 - λ ) x ( k , n ) {Y}^{*} ( k , n ) . \qquad Equation 10$$

Where Equations 9 and 10 are the approximations (using exponentially weighted moving average with a forgetting factor 0<λ<1 of E{x(k,n)x^{H}(k,n)} and E{x(k,n)Y*(k,n)}, respectively. Here, (.) * denotes the conjugate of a complex variable, (.) H denotes the Hermitian transpose of a vector matrix, and E {.} denotes the mathematical expectation. This design is the STFT-RLS AEC. The forgetting factor is determined by Equation 11 below.

$$λ = {e}^{- \frac{1}{τ * f s}} . \qquad Equation 11$$

In some embodiments of Equation 8, τ is the RLS's time constant and fs is the STFT's frame rate.

The beamformer 212 is configured to receive the refined audio data output by the multi-channel AEC component 210 and generate directional audio data (e.g., by applying a beamforming algorithm). Beamforming is a signal processing technique configured to extract the desired signal and reject interfering signals according to their spatial location. For example, when the person 114 is talking, multiple microphones on the head-wearable device 102 pick up the audio at different points in time based on their relative positions. The beamformer determines the directional representation for the audio by comparing the audio signals from the microphones. For example, speech from the user 110 in FIG. 1B will come from a different direction than the speech from the person 112 (or the screen 118). Using directional audio, the system may attribute audio data (e.g., speech) to different sources based on their relative locations. The system may label the audio data (or may forgo outputting captions or other outputs for audio from some sources).

The output of the beamformer 212 can include more channels than the inputs. For example, the beamformer 212 may output a number of channels corresponding to a desired segment size for segmenting the environment, whereas the number of input channels may be based on a number of microphones capturing audio data and sending it to the beamformer 212. In some embodiments, the beamformer 212 receives N-channels of audio data from N microphones 202 and outputs N+1 channels of directional audio data.

A directional ASR 220 is configured to receive the beamformed audio data (e.g., directional audio data) and distinguish between the speech from multiple sources (e.g., the user 110 wearing the head-wearable device 102 and the speech from other people) based on their direction (and/or audio qualities of the audio data such as using voice recognition). The distinguished speech may be labeled and presented to the user (e.g., in a spatialized manner).

Performing the multi-channel AEC processing prior to beamforming can leave residual echoes in the audio data. These residual echoes can adversely affect the accuracy if the ASR 220 if the ASR 220 has not been trained to handle such residual echoes. In some embodiments, the ASR 220 includes a deep neural network (DNN) model and/or a recurrent neural network (RNN) model trained to detect the residual audio data that is a result of the multi-channel AEC processing. In some embodiments, the ASR 220 is trained using an AEC-aware multiple channel training approach. For example, the training data used to train the ASR 220 may be processed with a multi-path AEC algorithm (e.g., a dual-path AEC) to remove the echo as much as possible. This training data enables the model(s) of the ASR 220 to learn to process audio data containing residual echoes. In some embodiments, the model(s) are fine-tuned to recognize the speech in the presence of the residual echo effects left after the multi-channel AEC processing is complete. In this way, the accuracy of the ASR 220 may be improved.

In one example of a model configuration, each beamformer direction includes an 80-dimensional log-Mel filterbank where features are extracted. Input features from all channels (e.g., all audio channels that receive audio data) are then fed into the Convolutional front-end, which consists of 2 Conv2d blocks each with 5 channels, filters of size 2×5 and a stride setting of 1×2. The Conv2d blocks refer to two consecutive convolutional layers within a neural network, where each layer applies a 2-dimensional convolution operation to extract features from the input data. Then, six consecutive frames are stacked to form a 320-dimensional vector, reducing the sequence length by 6×. This is followed by 20 Emformer layers, each with 4 attention heads and 2048-dimensional feed-forward layers. The RNN-T's prediction network contains one 256-dimensional LSTM layer with layer normalization and dropout. Lastly, the encoder and predictor outputs are both projected to 768 dimensions and passed to an additive joiner network, which contains a ReLU followed by linear layer with 9001 output Sentence Piece based units. All models (e.g., DNN and/or RNN) are trained for 8 epochs, with an Adamsam optimizer, a tri-stage learning-rate scheduler with a base learning rate of 0.0005, and a warmup of 10,000 batches. An epoch is a fixed date and time that a computer uses as a reference to measure system time. For the model training, the pre-trained model is trained with one additional epoch.

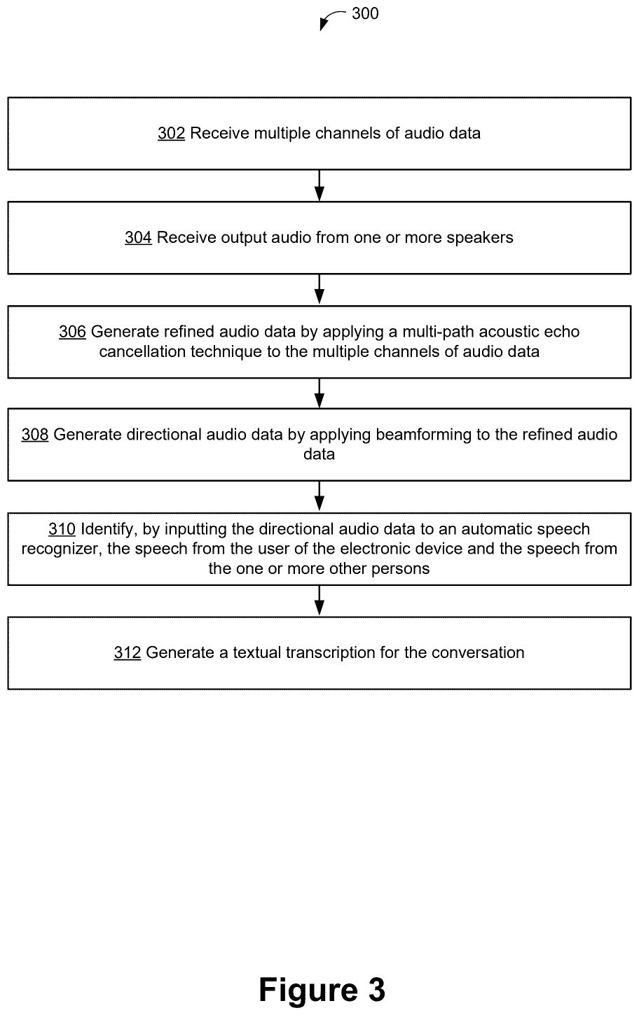

FIG. 3 illustrates a flow diagram of a method of determining directional speech, in accordance with some embodiments. Operations (e.g., steps) of the method 300 can be performed by one or more processors (e.g., central processing unit and/or MCU) of a system (e.g., including a head-wearable device and a wrist-wearable device). At least some of the operations shown in FIG. 3 correspond to instructions stored in a computer memory or computer-readable storage medium (e.g., storage, RAM, and/or memory) of an electronic device (e.g., a head-wearable device or wrist-wearable device). Operations of the method 300 can be performed by a single device alone or in conjunction with one or more processors and/or hardware components of another communicatively coupled device (e.g., head-wearable device 102 and/or wrist-wearable device 104) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) FIG. 3 shows a flow chart of a method 300 of determining directional speech, in accordance with some embodiments. For example, the method described below can be used to leverage a multi-microphone array to discern speakers and differentiate between the user, a conversation partner, and unrelated bystanders or other noise.

The method 300 occurs at an electronic device (e.g., the head-wearable device 102) that includes, or is in communication with, one or more microphones, speakers, and a display. In some embodiments, the method 300 includes, receiving (302) multiple channels of audio data. In some embodiments, the multiple channels of audio data are received from a plurality of microphones (e.g., the microphones 132-140, FIG. 1A), where the multiple channels of audio data comprise speech from a user (e.g., the user 110) of the electronic device and speech from one or more other persons (e.g., the person 112, FIG. 1A). In some embodiments, one or more of the microphones are components of the electronic device as illustrated in FIG. 1A. In some embodiments, one or more of the microphones are communicatively coupled to the electronic device.

The electronic device receives (304) output audio data from one or more speakers and in some embodiments the output audio data comprises speech generated using a text-to-speech technique. As illustrated in FIG. 1A, the one or more speakers can include the speaker 150, the speakers 142 and 144, and/or other speakers. In some embodiments, the one or more speakers are components of the electronic device. In some embodiments, the one or more speakers are communicatively coupled to the electronic device.

The electronic device generates (306) refined audio data by applying a multi-path AEC technique to the multiple channels of audio data. In some embodiments, the output audio data from the one or more speakers is used as reference data (e.g., indicating how at least a portion of the audio data captured by the microphones was initially output).

The electronic device generates (308) directional audio data by applying beamforming to the refined audio data. In some embodiments, the directional audio data has more channels than the multiple channels of audio data. For example, the multiple channels of audio data can include 2-7 channels and the directional audio data can include 8-15 channels.

The electronic device identifies (310), by inputting the directional audio data to an ASR, the speech from the user of the electronic device and the speech from the one or more other persons.

The electronic device generates (312) a generating a textual transcription for the conversation. In some embodiments, the textual transcription does not include the speech from the user of the electronic device. In some embodiments, the electronic device is configured to provide speech-to-text (STT) output.

(A2) In some embodiments of A1, the multi-path AEC technique includes applying a linear filter to the multiple channels of audio data. As an example, the multi-path AEC technique may be performed by the multi-channel AEC component 210.

(A3) In some embodiments of A2, applying the linear filter comprises applying a short-time Fourier transform (STFT) to remove echoing from the multiple channels of audio data. In some embodiments, a fast Fourier transform (FFT) is applied to remove the echoing as described previously with reference to FIG. 2.

(A4) In some embodiments of any of A2-A3, applying the linear filter comprises applies a recursive least squares (RLS) algorithm to remove echoing from the multiple channels of audio data. In some embodiments, the RLS algorithm is applied to an output of the STFT as described previously with reference to FIG. 2.

(A5) In some embodiments of any of A2-A4, the linear filter comprises a single-time varying linear filter configured to prevent distortion of the multiple channels of audio data. In some embodiments, a linear filter is used to preserve the directional aspects of the audio signal as described previously with reference to FIG. 2.

(A6) In some embodiments of any of A1-A5, the ASR comprises a trained AEC-aware model. For example, the AEC-aware model may be a deep neural network (DNN) model or a recurrent neural network (RNN) model.

(A7) In some embodiments of A6, the AEC-aware model (e.g., a component of the directional ASR 220) is configured to differentiate between speech in the directional audio data and a residual echo from the multi-path AEC technique. In some embodiments, the ASR is configured to identify residual echoes from AEC outputs and is fine-tuned using AEC-processed audio data.

(A8) In some embodiments of any of A1-A7, the ASR (e.g., the directional ASR 220) is trained recognize speech in the directional audio data.

(A9) In some embodiments of any of A1-A8, the conversation is in a first language and the textual transcription is in a second language. In some embodiments, the system (e.g., the ASR or a translation component coupled to the output of the ASR) translates words spoken in a first language (e.g., Spanish) and transcribes them into another language (e.g., English), e.g., so the user can understand what the other person is trying to communicate to them.

(A10) In some embodiments of any of A1-A9, for each portion of speech in the multiple channels of audio data, the ASR is configured to identify which person is speaking and the textual transcription includes an indication of which person is speaking.

(A11) In some embodiments of any of A1-A10, the speech from the user of the electronic device and the speech from one or more other persons correspond to conversation between the user and the one or more other persons.

(A12) In some embodiments of any of A1-A11, the speech from the user of the electronic device comprises speech in a first language, and the speech from one or more other persons comprises speech in a second language.

(A13) In some embodiments of any of A1-A12, the multiple channels of audio data comprises a respective channel of audio data for each microphone in the plurality of microphones. For example, an electronic device with 5 microphones may have 5 channels of audio data with each channel corresponding to a different microphone.

(A14) In some embodiments of any of A1-A13, generating the directional audio data comprises splitting the multiple channels of audio data into a set number of audio channels corresponding to different regions of space around the electronic device. In some embodiments, the directional audio is generated by a beamforming component. In an example, the beamforming component may be configured to generate 13 channels of directional audio (corresponding to 13 segments of the 3-D space around the user). For example, a first channel may correspond to a space in front of the user, a second channel may correspond to a space to the right of the user, and a third channel may correspond to a space to the left of the user. In some embodiments, one of the channels of directional audio data corresponds to a mouth of the user. In some embodiments, the directional audio data includes a channel of audio data corresponding to a mouth of the user.

(A15) In some embodiments of any of A1-A14, microphones of the plurality of microphones are located at distinct locations on the electronic device, and generating the directional audio data includes accounting for the relative positions of the microphones of the plurality of microphones. In some embodiments, the plurality of microphones include the microphone 132, the microphone 134, the microphone 136, the microphone 138, and the microphone 140.

(A16) In some embodiments of any of A1-A15, the electronic device (e.g., head-wearable device 102) comprises a wearable device.

(A17) In some embodiments of any of A1-A16, the wearable device comprises an extended-reality headset. In some embodiments, the wearable device comprises an augmented-reality headset, smart glasses, or a virtual-reality headset.

(A18) In some embodiments of any of A1-A17, the method further comprises presenting the textual transcription for the conversation on a display. In some embodiments, the display is a component of the electronic device. In some embodiments, the display is communicatively coupled to the electronic device.

(B1) In accordance with some embodiments, a method of providing real time automatic transcription is performed at an extended-reality headset. The method includes receiving directional audio at a microphone of an extended-reality headset and in response to receiving the directional audio at the microphone of the extended reality headset, applying a dual path AEC algorithm to the directional audio. The algorithm is configured to determine portions of audio emanating from a wearer of the extended-reality headset. The method further includes presenting a textual transcription at the extended-reality headset. The textual transcription does not include a transcription of the portions of the audio emanating from the wearer of the extended-reality headset.

(C1) In accordance with some embodiments, a method of providing real time automatic transcription at an extended-reality headset, including receiving directional audio at a microphone of an extended-reality headset and in response to receiving the directional audio at the microphone of the extended reality headset, applying a dual path AEC algorithm, and applying at least one of a STFT and a RLS algorithm to the directional audio, thereby determining portions of audio emanating from a wearer of the extended-reality headset. The method further includes presenting a textual transcription at the extended-reality headset. The textual transcription does not include a transcription of the portions of the audio emanating from the wearer of the extended-reality headset.

In another aspect, some embodiments include a computing system (e.g., comprising the head-wearable device 102, the wrist-wearable device 104, the smartphone 130, and/or other electronic components, such as a server device) including control circuitry (e.g., one or more processors) and memory coupled to the control circuitry, the memory storing one or more sets of instructions configured to be executed by the control circuitry, the one or more sets of instructions including instructions for performing any of the methods described herein (e.g., A1-A18, B1, and C1 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A18, B1, and C1 above).

### Example Extended-Reality Systems

FIGS. 4A, 4B, 4C-1, and 4C-2, illustrate example XR systems that include AR and MR systems, in accordance with some embodiments. FIG. 4A shows a first XR system 400a and first example user interactions using a wrist-wearable device 426, a head-wearable device (e.g., AR device 428), and/or a HIPD 442. FIG. 4B shows a second XR system 400b and second example user interactions using a wrist-wearable device 426, AR device 428, and/or an HIPD 442. FIGS. 4C-1 and 4C-2 show a third MR system 400c and third example user interactions using a wrist-wearable device 426, a head-wearable device (e.g., an MR device such as a VR device), and/or an HIPD 442. As the skilled artisan will appreciate upon reading the descriptions provided herein, the above-example AR and MR systems (described in detail below) can perform various functions and/or operations.

The wrist-wearable device 426, the head-wearable devices, and/or the HIPD 442 can communicatively couple via a network 425 (e.g., cellular, near field, Wi-Fi, personal area network, wireless LAN). Additionally, the wrist-wearable device 426, the head-wearable device, and/or the HIPD 442 can also communicatively couple with one or more servers 430, computers 440 (e.g., laptops, computers), mobile devices 450 (e.g., smartphones, tablets), and/or other electronic devices via the network 425 (e.g., cellular, near field, Wi-Fi, personal area network, wireless LAN). Similarly, a smart textile-based garment, when used, can also communicatively couple with the wrist-wearable device 426, the head-wearable device(s), the HIPD 442, the one or more servers 430, the computers 440, the mobile devices 450, and/or other electronic devices via the network 425 to provide inputs.

Turning to FIG. 4A, a user 402 is shown wearing the wrist-wearable device 426 and the AR device 428 and having the HIPD 442 on their desk. The wrist-wearable device 426, the AR device 428, and the HIPD 442 facilitate user interaction with an AR environment. In particular, as shown by the first AR system 400a, the wrist-wearable device 426, the AR device 428, and/or the HIPD 442 cause presentation of one or more avatars 404, digital representations of contacts 406, and virtual objects 408. As discussed below, the user 402 can interact with the one or more avatars 404, digital representations of the contacts 406, and virtual objects 408 via the wrist-wearable device 426, the AR device 428, and/or the HIPD 442. In addition, the user 402 is also able to directly view physical objects in the environment, such as a physical table 429, through transparent lens(es) and waveguide(s) of the AR device 428. Alternatively, an MR device could be used in place of the AR device 428 and a similar user experience can take place, but the user would not be directly viewing physical objects in the environment, such as table 429, and would instead be presented with a virtual reconstruction of the table 429 produced from one or more sensors of the MR device (e.g., an outward facing camera capable of recording the surrounding environment).

The user 402 can use any of the wrist-wearable device 426, the AR device 428 (e.g., through physical inputs at the AR device and/or built-in motion tracking of a user's extremities), a smart-textile garment, externally mounted extremity tracking device, the HIPD 442 to provide user inputs, etc. For example, the user 402 can perform one or more hand gestures that are detected by the wrist-wearable device 426 (e.g., using one or more EMG sensors and/or IMUs built into the wrist-wearable device) and/or AR device 428 (e.g., using one or more image sensors or cameras) to provide a user input. Alternatively, or additionally, the user 402 can provide a user input via one or more touch surfaces of the wrist-wearable device 426, the AR device 428, and/or the HIPD 442, and/or voice commands captured by a microphone of the wrist-wearable device 426, the AR device 428, and/or the HIPD 442. The wrist-wearable device 426, the AR device 428, and/or the HIPD 442 include an artificially intelligent digital assistant to help the user in providing a user input (e.g., completing a sequence of operations, suggesting different operations or commands, providing reminders, confirming a command). For example, the digital assistant can be invoked through an input occurring at the AR device 428 (e.g., via an input at a temple arm of the AR device 428). In some embodiments, the user 402 can provide a user input via one or more facial gestures and/or facial expressions. For example, cameras of the wrist-wearable device 426, the AR device 428, and/or the HIPD 442 can track the user 402's eyes for navigating a user interface.

The wrist-wearable device 426, the AR device 428, and/or the HIPD 442 can operate alone or in conjunction to allow the user 402 to interact with the AR environment. In some embodiments, the HIPD 442 is configured to operate as a central hub or control center for the wrist-wearable device 426, the AR device 428, and/or another communicatively coupled device. For example, the user 402 can provide an input to interact with the AR environment at any of the wrist-wearable device 426, the AR device 428, and/or the HIPD 442, and the HIPD 442 can identify one or more back-end and front-end tasks to cause the performance of the requested interaction and distribute instructions to cause the performance of the one or more back-end and front-end tasks at the wrist-wearable device 426, the AR device 428, and/or the HIPD 442. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 442 can perform the back-end tasks and provide the wrist-wearable device 426 and/or the AR device 428 operational data corresponding to the performed back-end tasks such that the wrist-wearable device 426 and/or the AR device 428 can perform the front-end tasks. In this way, the HIPD 442, which has more computational resources and greater thermal headroom than the wrist-wearable device 426 and/or the AR device 428, performs computationally intensive tasks and reduces the computer resource utilization and/or power usage of the wrist-wearable device 426 and/or the AR device 428.

In the example shown by the first AR system 400a, the HIPD 442 identifies one or more back-end tasks and front-end tasks associated with a user request to initiate an AR video call with one or more other users (represented by the avatar 404 and the digital representation of the contact 406) and distributes instructions to cause the performance of the one or more back-end tasks and front-end tasks. In particular, the HIPD 442 performs back-end tasks for processing and/or rendering image data (and other data) associated with the AR video call and provides operational data associated with the performed back-end tasks to the AR device 428 such that the AR device 428 performs front-end tasks for presenting the AR video call (e.g., presenting the avatar 404 and the digital representation of the contact 406).

In some embodiments, the HIPD 442 can operate as a focal or anchor point for causing the presentation of information. This allows the user 402 to be generally aware of where information is presented. For example, as shown in the first AR system 400a, the avatar 404 and the digital representation of the contact 406 are presented above the HIPD 442. In particular, the HIPD 442 and the AR device 428 operate in conjunction to determine a location for presenting the avatar 404 and the digital representation of the contact 406. In some embodiments, information can be presented within a predetermined distance from the HIPD 442 (e.g., within five meters). For example, as shown in the first AR system 400a, virtual object 408 is presented on the desk some distance from the HIPD 442. Similar to the above example, the HIPD 442 and the AR device 428 can operate in conjunction to determine a location for presenting the virtual object 408. Alternatively, in some embodiments, presentation of information is not bound by the HIPD 442. More specifically, the avatar 404, the digital representation of the contact 406, and the virtual object 408 do not have to be presented within a predetermined distance of the HIPD 442. While an AR device 428 is described working with an HIPD, an MR headset can be interacted with in the same way as the AR device 428.

User inputs provided at the wrist-wearable device 426, the AR device 428, and/or the HIPD 442 are coordinated such that the user can use any device to initiate, continue, and/or complete an operation. For example, the user 402 can provide a user input to the AR device 428 to cause the AR device 428 to present the virtual object 408 and, while the virtual object 408 is presented by the AR device 428, the user 402 can provide one or more hand gestures via the wrist-wearable device 426 to interact and/or manipulate the virtual object 408. While an AR device 428 is described working with a wrist-wearable device 426, an MR headset can be interacted with in the same way as the AR device 428.

Integration of Artificial Intelligence with XR Systems

FIG. 4A illustrates an interaction in which an artificially intelligent virtual assistant can assist in requests made by a user 402. The AI virtual assistant can be used to complete open-ended requests made through natural language inputs by a user 402. For example, in FIG. 4A the user 402 makes an audible request 444 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 4A also illustrates an example neural network 452 used in Artificial Intelligence applications. Uses of Artificial Intelligence (AI) are varied and encompass many different aspects of the devices and systems described herein. AI capabilities cover a diverse range of applications and deepen interactions between the user 402 and user devices (e.g., the AR device 428, an MR device 432, the HIPD 442, the wrist-wearable device 426). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 402 can interact with an AI model through natural language inputs captured by a voice sensor, text inputs, or any other input modality that accepts natural language and/or a corresponding voice sensor module. In another instance, input is provided by tracking the eye gaze of a user 402 via a gaze tracker module. Additionally, the AI model can also receive inputs beyond those supplied by a user 402. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 428) or from multiple devices that are in communication with each other (e.g., a system that includes at least two of an AR device 428, an MR device 432, the HIPD 442, the wrist-wearable device 426, etc.). The AI model can also access additional information (e.g., one or more servers 430, the computers 440, the mobile devices 450, and/or other electronic devices) via a network 425.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 428, an MR device 432, the HIPD 442, the wrist-wearable device 426) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 428, an MR device 432, the HIPD 442, the wrist-wearable device 426), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 442), haptic feedback can provide information to the user 402. An AI model can also use the inputs described above to determine the appropriate modality and device(s) to present content to the user (e.g., a user walking on a busy road can be presented with an audio output instead of a visual output to avoid distracting the user 402).

### Example Augmented Reality Interaction

FIG. 4B shows the user 402 wearing the wrist-wearable device 426 and the AR device 428 and holding the HIPD 442. In the second AR system 400b, the wrist-wearable device 426, the AR device 428, and/or the HIPD 442 are used to receive and/or provide one or more messages to a contact of the user 402. In particular, the wrist-wearable device 426, the AR device 428, and/or the HIPD 442 detect and coordinate one or more user inputs to initiate a messaging application and prepare a response to a received message via the messaging application.

In some embodiments, the user 402 initiates, via a user input, an application on the wrist-wearable device 426, the AR device 428, and/or the HIPD 442 that causes the application to initiate on at least one device. For example, in the second AR system 400b the user 402 performs a hand gesture associated with a command for initiating a messaging application (represented by messaging user interface 412); the wrist-wearable device 426 detects the hand gesture; and, based on a determination that the user 402 is wearing the AR device 428, causes the AR device 428 to present a messaging user interface 412 of the messaging application. The AR device 428 can present the messaging user interface 412 to the user 402 via its display (e.g., as shown by user 402's field of view 410). In some embodiments, the application is initiated and can be run on the device (e.g., the wrist-wearable device 426, the AR device 428, and/or the HIPD 442) that detects the user input to initiate the application, and the device provides another device operational data to cause the presentation of the messaging application. For example, the wrist-wearable device 426 can detect the user input to initiate a messaging application, initiate and run the messaging application, and provide operational data to the AR device 428 and/or the HIPD 442 to cause presentation of the messaging application. Alternatively, the application can be initiated and run at a device other than the device that detected the user input. For example, the wrist-wearable device 426 can detect the hand gesture associated with initiating the messaging application and cause the HIPD 442 to run the messaging application and coordinate the presentation of the messaging application.

Further, the user 402 can provide a user input provided at the wrist-wearable device 426, the AR device 428, and/or the HIPD 442 to continue and/or complete an operation initiated at another device. For example, after initiating the messaging application via the wrist-wearable device 426 and while the AR device 428 presents the messaging user interface 412, the user 402 can provide an input at the HIPD 442 to prepare a response (e.g., shown by the swipe gesture performed on the HIPD 442). The user 402's gestures performed on the HIPD 442 can be provided and/or displayed on another device. For example, the user 402's swipe gestures performed on the HIPD 442 are displayed on a virtual keyboard of the messaging user interface 412 displayed by the AR device 428.

In some embodiments, the wrist-wearable device 426, the AR device 428, the HIPD 442, and/or other communicatively coupled devices can present one or more notifications to the user 402. The notification can be an indication of a new message, an incoming call, an application update, a status update, etc. The user 402 can select the notification via the wrist-wearable device 426, the AR device 428, or the HIPD 442 and cause presentation of an application or operation associated with the notification on at least one device. For example, the user 402 can receive a notification that a message was received at the wrist-wearable device 426, the AR device 428, the HIPD 442, and/or other communicatively coupled device and provide a user input at the wrist-wearable device 426, the AR device 428, and/or the HIPD 442 to review the notification, and the device detecting the user input can cause an application associated with the notification to be initiated and/or presented at the wrist-wearable device 426, the AR device 428, and/or the HIPD 442.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 428 can present to the user 402 game application data and the HIPD 442 can use a controller to provide inputs to the game. Similarly, the user 402 can use the wrist-wearable device 426 to initiate a camera of the AR device 428, and the user can use the wrist-wearable device 426, the AR device 428, and/or the HIPD 442 to manipulate the image capture (e.g., zoom in or out, apply filters) and capture image data.

While an AR device 428 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 4C-1 and 4C-2, the user 402 is shown wearing the wrist-wearable device 426 and an MR device 432 (e.g., a device capable of providing either an entirely VR experience or an MR experience that displays object(s) from a physical environment at a display of the device) and holding the HIPD 442. In the third AR system 400c, the wrist-wearable device 426, the MR device 432, and/or the HIPD 442 are used to interact within an MR environment, such as a VR game or other MR/VR application. While the MR device 432 presents a representation of a VR game (e.g., first MR game environment 420) to the user 402, the wrist-wearable device 426, the MR device 432, and/or the HIPD 442 detect and coordinate one or more user inputs to allow the user 402 to interact with the VR game.

In some embodiments, the user 402 can provide a user input via the wrist-wearable device 426, the MR device 432, and/or the HIPD 442 that causes an action in a corresponding MR environment. For example, the user 402 in the third MR system 400c (shown in FIG. 4C-1) raises the HIPD 442 to prepare for a swing in the first MR game environment 420. The MR device 432, responsive to the user 402 raising the HIPD 442, causes the MR representation of the user 422 to perform a similar action (e.g., raise a virtual object, such as a virtual sword 424). In some embodiments, each device uses respective sensor data and/or image data to detect the user input and provide an accurate representation of the user 402's motion. For example, image sensors (e.g., SLAM cameras or other cameras) of the HIPD 442 can be used to detect a position of the HIPD 442 relative to the user 402's body such that the virtual object can be positioned appropriately within the first MR game environment 420; sensor data from the wrist-wearable device 426 can be used to detect a velocity at which the user 402 raises the HIPD 442 such that the MR representation of the user 422 and the virtual sword 424 are synchronized with the user 402's movements; and image sensors of the MR device 432 can be used to represent the user 402's body, boundary conditions, or real-world objects within the first MR game environment 420.

In FIG. 4C-2, the user 402 performs a downward swing while holding the HIPD 442. The user 402's downward swing is detected by the wrist-wearable device 426, the MR device 432, and/or the HIPD 442 and a corresponding action is performed in the first MR game environment 420. In some embodiments, the data captured by each device is used to improve the user's experience within the MR environment. For example, sensor data of the wrist-wearable device 426 can be used to determine a speed and/or force at which the downward swing is performed and image sensors of the HIPD 442 and/or the MR device 432 can be used to determine a location of the swing and how it should be represented in the first MR game environment 420, which, in turn, can be used as inputs for the MR environment (e.g., game mechanics, which can use detected speed, force, locations, and/or aspects of the user 402's actions to classify a user's inputs (e.g., user performs a light strike, hard strike, critical strike, glancing strike, miss) or calculate an output (e.g., amount of damage)).

FIG. 4C-2 further illustrates that a portion of the physical environment is reconstructed and displayed at a display of the MR device 432 while the MR game environment 420 is being displayed. In this instance, a reconstruction of the physical environment 446 is displayed in place of a portion of the MR game environment 420 when object(s) in the physical environment are potentially in the path of the user (e.g., a collision with the user and an object in the physical environment are likely). Thus, this example MR game environment 420 includes (i) an immersive VR portion 448 (e.g., an environment that does not have a corollary counterpart in a nearby physical environment) and (ii) a reconstruction of the physical environment 446 (e.g., table 429 and cup 452). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 426, the MR device 432, and/or the HIPD 442 are described as detecting user inputs, in some embodiments, user inputs are detected at a single device (with the single device being responsible for distributing signals to the other devices for performing the user input). For example, the HIPD 442 can operate an application for generating the first MR game environment 420 and provide the MR device 432 with corresponding data for causing the presentation of the first MR game environment 420, as well as detect the user 402's movements (while holding the HIPD 442) to cause the performance of corresponding actions within the first MR game environment 420. Additionally or alternatively, in some embodiments, operational data (e.g., sensor data, image data, application data, device data, and/or other data) of one or more devices is provided to a single device (e.g., the HIPD 442) to process the operational data and cause respective devices to perform an action associated with processed operational data.

In some embodiments, the user 402 can wear a wrist-wearable device 426, wear an MR device 432, wear smart textile-based garments 438 (e.g., wearable haptic gloves), and/or hold an HIPD 442 device. In this embodiment, the wrist-wearable device 426, the MR device 432, and/or the smart textile-based garments 438 are used to interact within an MR environment (e.g., any AR or MR system described above in reference to FIGS. 4A-4B). While the MR device 432 presents a representation of an MR game (e.g., second MR game environment 420) to the user 402, the wrist-wearable device 426, the MR device 432, and/or the smart textile-based garments 438 detect and coordinate one or more user inputs to allow the user 402 to interact with the MR environment.

In some embodiments, the user 402 can provide a user input via the wrist-wearable device 426, an HIPD 442, the MR device 432, and/or the smart textile-based garments 438 that causes an action in a corresponding MR environment. In some embodiments, each device uses respective sensor data and/or image data to detect the user input and provide an accurate representation of the user 402's motion. While four different input devices are shown (e.g., a wrist-wearable device 426, an MR device 432, an HIPD 442, and a smart textile-based garment 438) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 438) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 438 can be used in conjunction with an MR device and/or an HIPD 442.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 4A-4C-2 provided above are intended to augment the description provided in reference to FIGS. 1A-2. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if”′ can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer-readable storage medium storing one or more programs executable by one or more processors, the one or more programs comprising instructions for:
receiving, at an electronic device, multiple channels of audio data from a plurality of microphones, wherein the multiple channels of audio data comprise speech from a user of the electronic device and speech from one or more other persons;
receiving output audio data from one or more speakers, wherein the output audio data comprises speech generated using a text-to-speech technique;
generating refined audio data by applying a multi-path acoustic echo cancellation (AEC) technique to the multiple channels of audio data using the output audio data from the one or more speakers as reference data;
generating directional audio data by applying beamforming to the refined audio data, wherein the directional audio data has more channels than the multiple channels of audio data;
identifying, by inputting the directional audio data to an automatic speech recognizer (ASR), the speech from the user of the electronic device and the speech from the one or more other persons; and
generating a textual transcription for the speech from the one or more other persons, wherein the textual transcription does not include the speech from the user of the electronic device.

2. The non-transitory computer-readable storage medium of claim 1, wherein the multi-path AEC technique includes applying a linear filter to the multiple channels of audio data.

3. The non-transitory computer-readable storage medium of claim 2, wherein applying the linear filter comprises applies a short-time Fourier transform (STFT) to remove echoing from the multiple channels of audio data.

4. The non-transitory computer-readable storage medium of claim 2, wherein applying the linear filter comprises applying a recursive least squares (RLS) algorithm to remove echoing from the multiple channels of audio data.

5. The non-transitory computer-readable storage medium of claim 2, wherein the linear filter comprises a single-time varying linear filter configured to prevent distortion of the multiple channels of audio data.

6. The non-transitory computer-readable storage medium of claim 1, wherein the ASR comprises a trained AEC-aware model.

7. The non-transitory computer-readable storage medium of claim 6, wherein the trained AEC-aware model is configured to differentiate between speech in the directional audio data and a residual echo from the multi-path AEC technique.

8. The non-transitory computer-readable storage medium of claim 1, wherein the ASR is trained recognize speech in the directional audio data.

9. The non-transitory computer-readable storage medium of claim 1, wherein the speech from the one or more other persons is in a first language and the textual transcription is in a second language.

10. The non-transitory computer-readable storage medium of claim 1, wherein, for each portion of speech in the multiple channels of audio data:
the ASR is configured to identify which person is speaking; and
the textual transcription includes an indication of which person is speaking.

11. The non-transitory computer-readable storage medium of claim 1, wherein the speech from the user of the electronic device and the speech from one or more other persons correspond to conversation between the user and the one or more other persons.

12. The non-transitory computer-readable storage medium of claim 1, wherein the speech from the user of the electronic device comprises speech in a first language, and the speech from one or more other persons comprises speech in a second language.

13. The non-transitory computer-readable storage medium of claim 1, wherein the multiple channels of audio data comprises a respective channel of audio data for each microphone in the plurality of microphones.

14. The non-transitory computer-readable storage medium of claim 1, wherein generating the directional audio data comprises splitting the multiple channels of audio data into a set number of audio channels corresponding to different regions of space around the electronic device.

15. The non-transitory computer-readable storage medium of claim 1, wherein microphones of the plurality of microphones are located at distinct locations on the electronic device, and wherein generating the directional audio data comprises accounting for relative positions of the microphones of the plurality of microphones.

16. The non-transitory computer-readable storage medium of claim 1, wherein the electronic device comprises a wearable device.

17. The non-transitory computer-readable storage medium of claim 16, wherein the wearable device comprises an extended-reality headset.

18. The non-transitory computer-readable storage medium of claim 1, wherein the one or more programs further comprise instructions for presenting the textual transcription for speech from the one or more other persons on a display.

19. A method of providing speech-to-text transcription, the method comprising:
receiving, at an electronic device, multiple channels of audio data from a plurality of microphones, wherein the multiple channels of audio data comprise speech from a user of the electronic device and speech from one or more other persons;
receiving output audio data from one or more speakers;
generating refined audio data by applying a multi-path acoustic echo cancellation (AEC) technique to the multiple channels of audio data using the output audio data from the one or more speakers as reference data;
generating directional audio data by applying beamforming to the refined audio data, wherein the directional audio data has more channels than the multiple channels of audio data;
identifying, by inputting the directional audio data to an automatic speech recognizer (ASR), the speech from the user of the electronic device and the speech from the one or more other persons; and
generating a textual transcription for the speech from the one or more other persons, wherein the textual transcription does not include the speech from the user of the electronic device.

20. An electronic device comprising:
control circuitry;
memory coupled to the control circuitry, the memory storing instructions for:
receiving multiple channels of audio data from a plurality of microphones, wherein the multiple channels of audio data comprise speech from a user of the electronic device and speech from one or more other persons;
receiving output audio data from one or more speakers, wherein the output audio data comprises speech generated using a text-to-speech technique;
generating refined audio data by applying a multi-path acoustic echo cancellation (AEC) technique to the multiple channels of audio data using the output audio data from the one or more speakers as reference data;
generating directional audio data by applying beamforming to the refined audio data, wherein the directional audio data has more channels than the multiple channels of audio data;
identifying, by inputting the directional audio data to an automatic speech recognizer (ASR), the speech from the user of the electronic device and the speech from the one or more other persons; and
generating a textual transcription for the speech from the one or more other persons, wherein the textual transcription does not include the speech from the user of the electronic device.
